(19) United States
(12) Patent Application Publication
(10) Pub. No.: US 2026/0094000 A1
(43) Pub. Date: Apr. 2, 2026

(54) METHOD FOR CONSTRUCTING CONDITIONAL TEST LAYOUT GENERATOR

(71) Applicant: INSTITUE OF MICROELECTRONICS OF THE CHINESE ACADEMY OF SCIENCES, Beijing (CN)

(72) Inventors: Yajuan Su, Beijing (CN); Yuqin Wang, Beijing (CN); Yayi Wei, Beijing (CN)

(21) Appl. No.: 19/207,975

(22) Filed: May 14, 2025

(30) Foreign Application Priority Data
Sep. 30, 2024 (CN) 202411384672.7

(51) Int. Cl. G06N 3/094; G06N 3/0475

(52) U.S. Cl. CPC G06N 3/094; G06N 3/0475

(57) ABSTRACT

The present application relates to a method for constructing conditional test layout generator. The method comprises obtaining a preset number of original layouts, adding attribute label to each original layout to obtain first sample data sets; processing each first sample data set to obtain a second sample data set of each resolution; constructing a label embedding network, training the label embedding network based on a feature extraction network, a feature regression network and the first sample data sets to obtain a trained label embedding network; constructing a conditional generative adversarial network, wherein the conditional generative adversarial network comprises a conditional generator network and a discriminator network, the conditional generator network comprises a trained label embedding network and a generator network; training the conditional generative adversarial network, and thus obtaining the trained conditional generative adversarial network as a conditional test layout generator.

### CROSS-REFERENCE TO RELATED APPLICATIONS

This application claims priority to Chinese Patent Application No. 202411384672.7, filed on Sep. 30, 2024, which is hereby incorporated by reference in their entirety.

### TECHNICAL FIELD

The present application relates to the technical field of test layout, and in particular relates to a method for constructing conditional test layout generator.

### BACKGROUND

A test layout is a small set of design patterns that are highly diverse, which is indispensable for many computational lithography applications, such as calibration of lithography models, joint optimization of light source masks, and generation of hotspot training data etc. Therefore, how to obtain test layout is the focus of existing research.

Currently, it is common to use a generator network as a layout generator to generate test layouts. The layout is patterns based on a stream of vector data, pixelized layout images are typically used as samples to train the network and convert the generated images back into vector format. Since a test layout generative task not only needs to integrate layout features but also needs to generate the features. Therefore, smaller-sized sub-blocks are used in the pixelization to preserve the structural information of detailed graphics such as step (Jog). The layout images and the generated images will become more refined after pixelization, resulting in high-resolution images, which also increase the training difficulty of the GAN network. In order to reduce the features' complexity, the existing methods use Discrete Cosine Transform (DCT) signals corresponding to the layout patterns as the training data to generate samples, and then convert the DCT signals into the layout graphics by inverse transformation. At first, a DCT-generative adversarial network (GAN) is adopted to generate new low-frequency DCT signals. The DCT-GAN is trained beforehand to ensure that the output DCT signals are new but ultimately correspond to a valid layout.

However, nowadays, the layout testing is becoming more and more diversified and there are many scenarios, the existing test layout generative methods focus on the training process and are not capable of generating test layouts with specified layout attributes, cannot satisfy the diversified requirements of current layout testing.

### SUMMARY

In view of the above analysis, embodiments of the present application aim at providing a method for constructing conditional test layout generator, to solve the problem that existing test layout generative methods cannot generate test layouts with specified layout attributes.

An embodiment of the present application provides a method for constructing conditional test layout generator, comprising the following steps:
obtaining a preset number of original layouts, adding attribute label to each original layout to obtain first sample data sets; at the same time, processing each first sample data set to obtain a second sample data set of each resolution; wherein each attribute label is a specific value of a preset layout attribute;
constructing a label embedding network, training the label embedding network based on a feature extraction network, a feature regression network and the first sample data sets to obtain a trained label embedding network;
constructing a conditional generative adversarial network, wherein the conditional generative adversarial network comprises a conditional generator network and a discriminator network, the conditional generator network comprises the trained label embedding network and a generator network; training the conditional generative adversarial network based on the size of the test layouts to be generated, a preset number of channels, and the second sample data set of each resolution to obtain a trained conditional generative adversarial network;
using the conditional generator network in the trained conditional generative adversarial network as a conditional test layout generator.

Further, said layout attributes comprise layout density, layout complexity, E2L or L2L; wherein E2L denotes an end-to-line spacing and L2L denotes a line-to-line spacing.

Further, said feature extraction network is used to extract the features of inputted first layout samples to obtain feature vectors;
said feature regression network is used to map the received feature vectors to attribute labels;
said label embedding network is used to map the attribute labels back to the corresponding feature vectors.

Further, said label embedding network is trained by the following way:
after sequentially connecting said feature extraction network and said feature regression network, performing training based on the first sample data sets and a preset first loss function to obtain a trained feature regression network;
after connecting the input terminal of said label embedding network to the output terminal of the trained feature regression network, and connecting the output terminal of said label embedding network to the input terminal of the trained feature regression network, performing training based on each attribute label in said first sample data sets and a preset second loss function to obtain the trained label embedding network.

Further, the feature regression network is trained based on the first sample data sets and the preset first loss function by the following way:
setting the optimizer, learning rate, training parameters, and the first loss function which are used for the training process;
inputting each first layout sample in the first sample data sets into the feature extraction network, and adjusting the parameters of the feature regression network by back propagation and stochastic gradient descent (SGD), so that the first loss function is minimized, and then the trained feature regression network is obtained.

Further, the label embedding network is trained based on each attribute label in said first sample data sets and the preset second loss function by the following way:
setting the optimizer, learning rate, training parameters, and the second loss function which are used for the training process;
inputting each attribute label in the first sample data sets into the label embedding network, and adjusting the parameters of the label embedding network by SGD method, so that the second loss function is minimized, and then the trained label embedding network is obtained; wherein the parameters in the trained feature regression network remain unchanged.

Further, said feature extraction network comprises M extraction units connected in sequence, wherein the 1st to the M−1th extraction units all comprise two third convolutional layers and one pooling layer which are connected in sequence, and the Mth extraction unit comprises two third convolutional layers and one fourth convolutional layer which are connected in sequence; wherein the number of the extraction units is obtained according to the highest resolution of the test layouts to be generated.

Said feature regression network comprises two first convolutional layers connected in sequence.

Said label embedding network comprises two first convolutional layers connected in sequence.

Further, said first loss function L₁ is denoted as:

$${L}_{1} = \frac{1}{n} {\sum }_{i = 1}^{n} [ {( {T}_{h 2 y} ( {T}_{x 2 h} ( {x}_{i} ) ) - {y}_{i} )}^{2} ] ;$$

where n denotes the number of the first layout samples in the first sample data sets, xᵢ denotes the ith first layout sample, yᵢ denotes the attribute label corresponding to xᵢ, Tₓ₂ₕ(xᵢ) denotes the output result when the input of the feature extraction network is xᵢ; T_{h2y}(Tₓ₂ₕ(xᵢ)) denotes the output result when the input of the feature regression network is Tₓ₂ₕ(xᵢ).

Further, said second loss function L₂ is:

$${L}_{2} = \frac{1}{m} {\sum }_{{i}^{′} = 1}^{m} {E}_{γ□ N ( 0 , {σ}_{γ}^{2} )} [ {( {T}_{h 2 y} ( {T}_{y 2 h} ( {y}_{{i}^{′}}^{u} + γ ) ) - ( {y}_{{i}^{′}}^{u} + γ ) )}^{2} ] ;$$

where m denotes the number of attribute label types;

$${y}_{{i}^{′}}^{u}$$

denotes the attribute labels of the i′ type;

$${E}_{γ \sim N ( 0 , {σ}_{γ}^{2} )}$$

( ) denotes the expected value when random noise γ is added, wherein the noise γ satisfies the distribution N(0, σ_{γ}²);

$${T}_{y 2 h} ( {y}_{{i}^{′}}^{u} + γ )$$

denotes the output result when random noise γ is applied to input

$${y}_{{i}^{′}}^{u}$$

of the label embedding network;

$${T}_{h 2 y} ( {T}_{y 2 h} ( {y}_{{i}^{′}}^{u} + γ ) )$$

denotes the output result when input of the feature regression network is

$${T}_{y 2 h} ( {y}_{{i}^{′}}^{u} + γ ) ; N ( 0 , {σ}_{γ}^{2} )$$

denotes a normal distribution with a mean of 0 and a variance of

$${σ}_{γ}^{2} .$$

Further, said processing each first sample data set to obtain a second sample data set of each resolution comprises:
downsampling operation with different resolutions is performed on each first layout sample in each first sample data set respectively to obtain each second layout sample with resolution of 4×4, 8×8, 16×16, . . . , N/2×N/2, and then each first layout sample is used as each second layout sample with resolution of N×N, the second layout samples with the same resolution constitute the second sample data sets at different resolutions; wherein, N×N is the highest resolution required for the test layouts to be generated.

An embodiment of the present application provides a method for calibrating lithography model, comprising:
generating test layouts with specific layout attributes by a conditional test layout generator, wherein constructing the conditional test layout generator comprises the following steps: obtaining a preset number of original layouts, adding attribute label to each original layout to obtain first sample data sets; at the same time, processing each first sample data set to obtain a second sample data set of each resolution; wherein each attribute label is a specific value of a preset layout attribute; constructing a label embedding network, training the label embedding network based on a feature extraction network, a feature regression network and the first sample data sets to obtain a trained label embedding network; constructing a conditional generative adversarial network, wherein the conditional generative adversarial network comprises a conditional generator network and a discriminator network, the conditional generator network comprises the trained label embedding network and a generator network; training the conditional generative adversarial network based on the size of the test layouts to be generated, a preset number of channels, and the second sample data set of each resolution to obtain a trained conditional generative adversarial network; using the conditional generator network in the trained conditional generative adversarial network as a conditional test layout generator;
inputting the test layouts with the specific layout attributes into a lithography model to calibrate lithography model.

An embodiment of the present application provides a non-transitory machine-readable storage medium comprising instructions that when executed cause a processor of a computing device to:
obtaining a preset number of original layouts, adding attribute label to each original layout to obtain first sample data sets; at the same time, processing each first sample data set to obtain a second sample data set of each resolution; wherein each attribute label is a specific value of a preset layout attribute;
constructing a label embedding network, training the label embedding network based on a feature extraction network, a feature regression network and the first sample data sets to obtain a trained label embedding network;
constructing a conditional generative adversarial network, wherein the conditional generative adversarial network comprises a conditional generator network and a discriminator network, the conditional generator network comprises the trained label embedding network and a generator network; training the conditional generative adversarial network based on the size of the test layouts to be generated, a preset number of channels, and the second sample data set of each resolution to obtain a trained conditional generative adversarial network;
using the conditional generator network in the trained conditional generative adversarial network as a conditional test layout generator.

Compared to the prior art, the present application achieves at least one of the following beneficial effects:
the present application provides a method for constructing conditional test layout generator, by obtaining a preset number of original layouts and adding attribute label to each original layout to obtain first sample data sets, and processing each first sample data set to obtain a second sample data set of each resolution, and then constructing a label embedding network, and training said label embedding network based on a feature extraction network, a feature regression network and said first sample data sets to obtain a trained label embedding network, followed by constructing a conditional generative adversarial network which is composed of a conditional generator network and a discriminator network, the conditional generator network comprises a trained label embedding network and a generator network, finally training the conditional generative adversarial network based on the size of the test layouts to be generated, the preset number of channels and the second sample data set of each resolution, the trained conditional generator network is used as a conditional test layout generator, the generator thus constructed is capable of generating test layouts with specific layout attributes, which improves the utilization rate of computational resources, meets the diversified requirements of layout testing nowadays, and is capable of generating high-quality large-size continuous layouts with guaranteed diversity of generated layouts.

In the present application, the above technical solutions can also be combined, to implement more preferred combined solutions. Other features and advantages of the present application will be described in the subsequent specification, and part of the advantages can become apparent from the specification, or be understood through the implementation of the present application. The objects and other advantages of the present application can be implemented and obtained from the contents particularly illustrated in the specification and the drawings.

### BRIEF DESCRIPTION OF DRAWINGS

The drawings are merely for the purpose of illustrating the particular embodiments, and are not considered as limitation to the present application. Throughout the drawings, the same reference signs denote the same elements.

FIG. 1 is a flow chart of a method for constructing conditional test layout generator provided in an embodiment of the present application;

FIG. 2 is a connection schematic diagram of training a label embedding network provided in an embodiment of the present application;

FIG. 3 is a schematic diagram of the structure of a conditional generative adversarial network provided in an embodiment of the present application;

FIG. 4 is a schematic diagram of convolutional operation in a generator network provided in an embodiment of the present application;

FIG. 5 is a schematic diagram of the training process of a conditional generative adversarial network provided in an embodiment of the present application;

FIG. 6 is a schematic diagram of generated test layouts provided in an embodiment of the present application;

FIG. 7 is a schematic diagram of a generated large size continuous test layout provided in an embodiment of the present application;

FIG. 8 is a schematic diagram of the test layout generative image generated with the attribute label of layout density provided in an embodiment of the present application.

### DESCRIPTION OF EMBODIMENTS

Preferable embodiments of the present application will be particularly described below by referring to the drawings. The drawings form part of the present application, are used to explain the principle of the present application together with the embodiments of the present application, and are not limiting the scope of the present application.

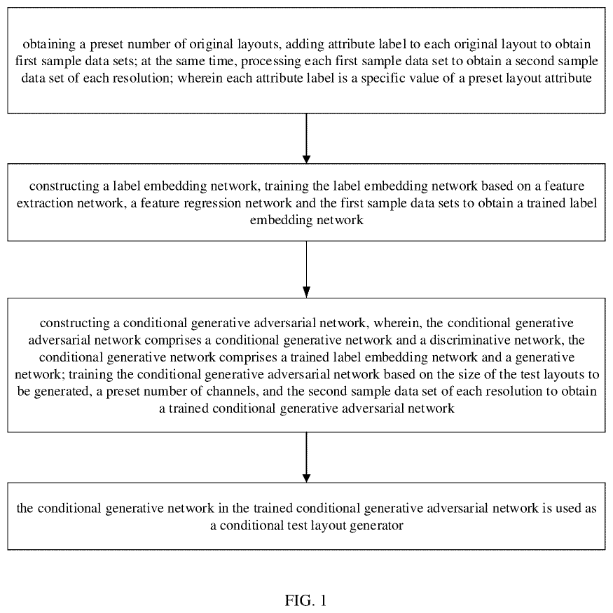

A specific embodiment of the present application discloses a method for constructing conditional test layout generator, as shown in FIG. 1, comprises the following steps:

S1, Obtaining a preset number of original layouts, adding attribute label to each original layout to obtain first sample data sets; at the same time, sampling each first layout sample in the first sample data sets at different resolutions to obtain second sample data sets of different resolutions; wherein each attribute label is a specific value of a preset layout attribute.

Specifically, the test layouts are integrated circuit test layouts, and the layout attributes comprise layout density, layout complexity, E2L, L2L; wherein E2L denotes an end-to-line spacing, L2L denotes a line-to-line spacing.

Specifically, the specific values of the layout attributes are used as attribute labels of the corresponding original layouts.

For example, the preset layout attribute is layout density, then the attribute labels comprise 0.10, 0.18, 0.26, 0.34, 0.40, and 0.48.

Specifically, the number of obtained original layouts is set according to the actual situation, preferably, the number is set to 500.

Specifically, said processing of each first sample data set to obtain a second sample data set at each resolution comprises:

Downsampling operations with different resolutions are performed on each first layout sample in each first sample data set respectively to obtain each second layout sample with resolution of 4×4, 8×8, 16×16, . . . , N/2×N/2, and then each first layout sample is used as each second layout sample with resolution of N×N, the second layout samples with the same resolution constitute the second sample data sets at different resolutions; wherein N×N is the highest resolution required for the test layouts to be generated. Wherein N denotes that there are N pixels in both the width direction and the height direction of the test layouts to be generated.

Preferably, the above downsampling operation may be embedded into a generative network, if an image is input, a second layout sample of the image with the desired resolution may be actively generated; that is, a layout sample is inputted into the network, then a second layout sample is generated, avoiding the problem of errors in different images with different resolutions.

S2, Constructing a label embedding network, training the label embedding network based on a feature extraction network, a feature regression network and the first sample data sets to obtain a trained label embedding network.

When implemented, said feature extraction network is used to extract the features of the inputted first layout samples to obtain feature vectors.

Said feature regression network is used to map the received feature vectors to attribute labels.

Said label embedding network is used to map the attribute labels back to the corresponding feature vectors.

When specifically implemented, as shown in FIG. 2,

Said feature extraction network comprises M extraction units connected in sequence, wherein the 1st to the M−1th extraction units all comprise two third convolutional layers and one pooling layer which are connected in sequence, and the Mth extraction unit comprises two third convolutional layers and one fourth convolutional layer which are connected in sequence; wherein the number of the extraction units is obtained according to the highest resolution of the test layouts to be generated.

Said feature regression network comprises two first convolutional layers connected in sequence.

Said label embedding network comprises two first convolutional layers connected in sequence.

Specifically, the number of the extraction units M in the feature extraction network is denoted as:

$$M = {log}_{2} N - 1.$$

More specifically, the first convolutional layer is a convolutional kernel of 1×1, the third convolutional layer is a convolutional kernel of 3×3, the fourth convolutional layer is a convolutional kernel of 4×4, and the pooling layer with kernel size of 2×2.

When implemented, said label embedding network is trained by the following way:

S21, After sequentially connecting said feature extraction network and said feature regression network, performing training based on the first sample data sets and a preset first loss function to obtain a trained feature regression network.

In particular embodiments, the feature regression network is trained based on the first sample data sets and the preset first loss function by the following way:
setting the optimizer, learning rate, training parameters, and the first loss function which are used for the training process.
inputting each first layout sample in the first sample data sets into the feature extraction network, and the parameters of the feature regression network are adjusted by back propagation and SGD, so that the first loss function is minimized, and then the trained feature regression network is obtained.

Specifically, in this embodiment, the optimizer adopts an Adam optimizer, the learning rate is 1e-6, and the training parameters are the specific data of the convolutional layers in each network, i.e., the training parameters are the specific values in the matrix.

Specifically, the training ends when the first loss function converges or has a value less than 10⁻⁵.

Specifically, the first loss function is denoted as:

$${L}_{1} = \frac{1}{n} {\sum }_{i = 1}^{n} [ {( {T}_{h 2 y} ( {T}_{x 2 h} ( {x}_{i} ) ) - {y}_{i} )}^{2} ] ;$$

where n denotes the number of the first layout samples in the first sample data sets, xᵢ denotes the ith first layout sample, yᵢ denotes the attribute label corresponding to xᵢ, Tₓ₂ₕ(xᵢ) denotes the output result when the input of the feature extraction network is xᵢ; T_{h2y}(Tₓ₂ₕ(xᵢ)) denotes the output result when the input of the feature regression network is Tₓ₂ₕ(xᵢ).

More specifically, the feature extraction network obtains the output result by performing matrix operation on the inputs of the network with the convolutional layers and pooling layers in the network, its output result is a feature matrix; the feature regression network obtains the output result by performing matrix operation on the inputs of the network with the convolutional layers in the network, i.e., obtains a specific value of a label.

S22, after connecting the input terminal of said label embedding network to the output terminal of the trained feature regression network, and connecting the output terminal of said label embedding network to the input terminal of the trained feature regression network, perform training based on each attribute label in said first sample data sets and a preset second loss function to obtain the trained label embedding network.

When implemented, the label embedding network is trained based on each attribute label in said first sample data sets and the preset second loss function by the following way:
setting the optimizer, learning rate, training parameters, and the second loss function which are used for the training process;
inputting each attribute label in the first sample data sets into the label embedding network, and adjusting the parameters of the label embedding network by SGD method, so that the second loss function is minimized, and then the trained label embedding network is obtained; wherein the parameters in the trained feature regression network remain unchanged.

Specifically, in this embodiment, the optimizer adopts an Adam optimizer, the learning rate is 1e-6, and the training parameters are the specific data of the convolutional layers in each network, i.e., the training parameters are the specific values in the matrix.

Specifically, the training ends when the second loss function is less than 10⁻⁵.

It should be noted that if all the first layout samples in the first sample data sets do not satisfy the second loss function is less than 10⁻⁵ after training, the result after training is judged, if the result after training satisfies the expectation, the training is ended, otherwise the first layout samples in the first sample data sets are then input to the network for training, preferably, the first sample data sets can also be data enhanced and then input to the network for subsequent training; all other training processes in this embodiment have the same setting.

Specifically, said second loss function is:

$${L}_{2} = \frac{1}{m} {\sum }_{{i}^{′} = 1}^{m} {E}_{γ ∼ N ( 0 , {σ}_{γ}^{2} )} [ {( {T}_{h 2 y} ( {T}_{y 2 h} ( {y}_{{i}^{′}}^{u} + γ ) ) - ( {y}_{{i}^{′}}^{u} + γ ) )}^{2} ] ;$$

where m denotes the number of attribute label types;

$${y}_{{i}^{′}}^{u}$$

denotes the attribute labels of the i′ type;

$${E}_{γ ∼ N ( 0 , {σ}_{γ}^{2} )}$$

( ) denotes the expected value when random noise γ is added, wherein the noise γ satisfies the distribution N(0, σ_{γ}²);

$${T}_{y 2 h} ( {y}_{{i}^{′}}^{u} + γ )$$

denotes the output result when random noise γ is applied to input

$${y}_{{i}^{′}}^{u}$$

of the label embedding network;

$${T}_{h 2 y} ( {T}_{y 2 h} ( {y}_{{i}^{′}}^{u} + γ ) )$$

denotes the output result when input of the feature regression network is

$${T}_{y 2 h} ( {y}_{{i}^{′}}^{u} + γ ) ; N ( 0 , {σ}_{γ}^{2} )$$

denotes a normal distribution with a mean of 0 and a variance of

$${σ}_{γ}^{2} .$$

More specifically, attribute labels with the same specific value are treated as the same attribute label type.

More specifically, the label embedding network obtains the output matrix by performing matrix operation on the inputs of the network with convolutional layers in the network.

Understandably, in this embodiment, in order to import continuous attribute labels, the attribute labels are mapped to the vector space by a label embedding network T_{y2h}. In order to enable the label embedding network to learn the relationship between the attribute labels and the latent vector space, the training of the label embedding network is aided by the feature extraction network Tₓ₂ₕ and the feature regression network T_{h2y}, the feature extraction network maps the first layout samples to a feature vector space, the feature regression network maps the extracted feature vectors to the attribute labels. Specifically, the feature extraction network and the feature regression network are sequentially connected together firstly and trained by the first layout sample x and its corresponding attribute label y in the first sample data sets, the trained feature extraction network can be regarded as a feature extractor and the extracted feature h is related to the attribute label y, the vicinaling attribute labels correspond to similar feature vectors; the label embedding network is then connected in front of the trained feature regression network, and freezing all the parameters in the trained feature regression network, training the label embedding network by the output results of the trained feature regression network, so that the label embedding network is able to map any attribute label back to its corresponding feature vector h.

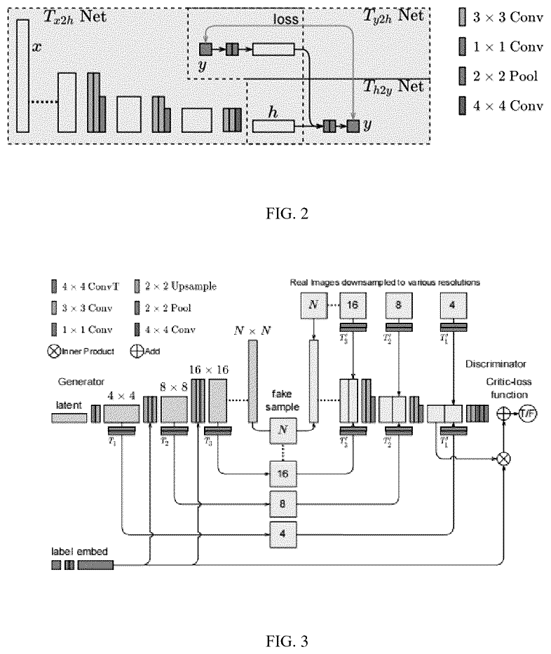

S3, constructing a conditional generative adversarial network, as shown in FIG. 3, wherein the conditional generative adversarial network comprises a conditional generator network and a discriminator network, the conditional generator network comprises a trained label embedding network and a generator network; training the conditional generative adversarial network based on the size of the test layouts to be generated, a preset number of channels, and the second sample data set of each resolution to obtain a trained conditional generative adversarial network.

When implemented, said conditional generator network is used to generate images according to received random latent vectors and attribute labels.

Said generator network is used to generate layout generative images of each resolution step by step according to received random latent vectors and attribute label feature vectors until generating a layout generative image with the highest resolution; wherein said attribute label feature vectors are obtained by the trained label embedding network, said random latent vectors are generated based on the size of the test layouts to be generated and the preset number of channels, the highest resolution of said layout generative images is the highest resolution of the test layouts to be generated;

Said discriminator network is used to receive, step by step from the highest resolution, the layout generative images or the second layout samples of the corresponding resolution to obtain a layout identification matrix of the corresponding resolution; and then obtaining the label identification matrix based on the received generative images and the second layout samples of the lowest resolution, as well as the attribute label feature vectors, obtaining the discriminator result of the discriminator network based on the layout identification matrix and the label identification matrix, wherein said discriminator result is a discriminator probability that the received layout generative images or the second layout samples of the highest resolution are real layouts.

When implemented, said generator network comprises a number of generative blocks connected in sequence, as well as transformation networks which are connected to the outputs of each generative block and correspond to them one by one; wherein the number of the generative blocks is obtained according to the highest resolution of the test layouts to be generated; wherein,
the 1st generative block is used to extract the features of the received random latent vectors and the attribute label feature vectors to generate the feature vectors of c_{L}×4×4; wherein c_{L} denotes the preset number of channels;
the i_{g} th generative block is used to extract the features of the received feature vectors and attribute label feature vectors output by the previous generative block, to generate the feature vector

$$\frac{{c}_{L}}{{2}^{{i}_{g} - 1}} \times {2}^{{i}_{g} + 1} \times {2}^{{i}_{g} + 1}$$

the i_{g} th transformation network is used to receive the feature vectors output by the i_{g} th generative block and transform them into the layout generative images of the corresponding resolution;
wherein i_{g} is greater than 1.

It should be noted that the layout generative images inputted into the discriminator network can be consistent with the number of channels of the second layout sample feature vectors via the designed transformation networks in the present embodiment. Specifically, the size of the generated sample after the random latent vectors are projected into the three-dimensional space is the number of the channels, which is generally 2 to the power of n, e.g., 256, 512, this type of data is easier to be accepted by computers, but for a real sample (image), its number of channels is 1 (grayscale image) or 3 (color image), so what a transformation network is intended to ensure that the number of channels of the real sample is the same as that of the generated image; the transformation network of the generator network is to convert the number of channels of the generated image from 2 to the power of n to 3 (color image), so that the generated sample image can be seen.

Specifically, the number of channels is set according to the complexity of the test layouts to be generated, and the more details contained in the test layouts, the more the number of channels needs to be set so that the network learns enough features.

Specifically, the number of generative blocks N_{g} in the generator network is denoted as:

$${N}_{g} = {log}_{2} N - 1.$$

Specifically, said 1st generative block comprises one transposed convolutional layer and one third convolutional layer connected in sequence;
said i_{g} th generative block comprises one upsampling layer, one transposed convolutional layer and one third convolutional layer connected in sequence.
said transformation network comprises two first convolutional layers connected in sequence.

More specifically, the 1st generative block projects the random latent vectors into the three-dimensional space, wherein the random latent vectors are obtained by random sampling in the latent space, satisfying a normal distribution with a mean of 0 and a standard deviation of 1.

It should be noted that the latent space is a concept in deep learning, defined as an abstract multidimensional space, which is generally composed of unobservable random variables, while in computer languages, it is generally sufficient to generate random vectors of the desired size using a random generative function.

More specifically, said transposed convolutional layer is a convolutional kernel of 4×4 and the upsampling layer is a sampling window of 2×2.

Understandably, the generator network is designed as a full convolutional neural network architecture in the present embodiment, which is capable of generating large-size continuous layouts by utilizing the property that the full convolutional neural network does not limit the size of its input.

For example, in the first generative block of the generator network, the first 4×4 transposed convolutional layer is able to expand a latent vector with a planar dimension of 1×1 into a feature image with a planar dimension of 4×4, features of the feature image are synthesized by a subsequent 3×3 convolutional layer to transform the local details. If the generative layout images of multiple latent vectors are spliced together, since there is no information interaction during the image generating process, there will inevitably be graphical discontinuity issues at the stitches. In the framework of full convolution, the planar dimension of the latent vectors can be extended and re-inputted. As shown in FIG. 4, the input of the generator network is a latent tensor with a planar dimension of 2×2, the sliding step of the first 4×4 transposed convolutional layer is set to 4×4, it is equivalent to still perform independent deconvolution on each latent vector, generating a 4×4 feature image with 2×2 distribution, that is, the total planar dimension is 8×8. And the subsequent 3×3 convolutional layer will fuse the vicinaling information in 4 feature images together when performing feature synthesis. For example, the convolution operation demonstrated in FIG. 4 combines some of the edge information of the 4 independent feature images to perform operations, so the output features will contain all the information. After multiple levels of convolution and feature generation, the information in the 4 latent vectors is fully fused and the local details at the boundaries will be reasonable and coherent. After arbitrarily extending the planar dimension of the input latent tensors, the network can generate continuous regional layouts of any size.

When implemented, the said discriminator network comprises a number of discriminator blocks connected in sequence, first inverse transformation networks connected to the discriminator blocks and corresponding to them one by one, and second inverse transformation networks connected to the discriminator blocks and corresponding to them one by one; wherein the number of the discriminator blocks is the same as the number of the generative blocks, both are N_{g}; wherein,
the jth first inverse transformation network is used to receive the layout generative image output by the N_{g}+1-jth transformation network and generate it into a corresponding feature vector;
the jth second inverse transformation network is used to receive a second layout sample which has the same resolution as the layout generative image output by the N_{g}+1-jth transformation network and generate it into a corresponding feature vector;
the 1st discriminator block is used to obtain the layout identification matrix at the highest resolution based on the feature vectors of the received second layout samples or the layout generated samples;
the 2nd to the N_{g}−1th discriminator blocks are all used to obtain a probability matrix at the corresponding resolution based on the feature vectors of the received layout generative images or the second layout samples, and the feature vector output by the previous discriminator block;
the N_{g} th discriminator block is used to obtain the layout identification matrix at the lowest resolution based on the feature vectors of the received layout generative images or the second layout samples or second layout samples, and the feature vectors output by the previous discriminator block; and is also used to obtain the label identification matrix based on the feature vectors of the received layout generative images or the second layout samples, and the attribute label feature vectors, and to obtain the discriminator result of the discriminator network based on the layout identification matrix and the label identification matrix;
wherein, the elements of the layout identification matrix at each resolution are a discriminator probability that each pixel point in the received layout generated samples or the second layout samples at each resolution is from a real layout.

When implemented, said the 1st to the N_{g}−1th discriminator blocks all comprise two third convolutional layers and one pooling layer connected in sequence;
said the N_{g} th discriminator block comprises two third convolutional layers, one fourth convolutional layer and two first convolutional layers connected in sequence.

Said first inverse transformation network and second inverse transformation network both comprise two transposed convolutional layers.

Understandably, through the setting of each discriminator block of the discriminator network, it is capable of flowing the gradient from the middle layer of the discriminator block to the middle layer of the generative block, and it is easy to reach the initial block by the transformation network, so the training will be relatively stable.

When implemented, the label identification matrix is obtained by inner product of feature vectors of the received layout generative images or the second layout samples with the attribute label feature vectors; wherein, the inner product is a matrix operation.

When implemented, said conditional generative adversarial network is trained by the following way:
said conditional generative adversarial network is sequentially trained for K times and executed in the kth training:
assuming that the conditional generator network has only the first k generative blocks, the discriminator network contains the last k discriminator blocks, the first k generative blocks and the last k discriminator blocks are trained based on the second sample data sets with a resolution of 2^{k+1}×2^{k+1}, wherein,
if k is greater than 1, then the parameters of the first k−1 generative blocks and the last k−1 discriminator blocks use the parameters of the first k−1 generative blocks and the last k−1 discriminator blocks after the last training is completed;
if k is less than N_{g}, then the feature vector output by the kth generative block is used as the feature vector output by the previous discriminator block received by the penultimate kth discriminator block;
wherein, K=N_{g}.

In other words, the conditional generative adversarial network executes the following steps during the 1st training:
assuming that there is only the first generative block in the conditional generator network and only the last discriminator block in the discriminator network, the first generative block and the last discriminator block are trained based on the second sample data sets with a resolution of 4×4, completing the training; wherein, the feature vector output by the first generative block is used as the feature vector output by the previous discriminator block received by the last discriminator block;
the conditional generative adversarial network executes the following steps during the 2nd training:
assuming that generative blocks in the conditional generator network comprise the first 2 generative blocks and discriminator blocks in the discriminator network comprise the last 2 discriminator blocks, the first 2 generative blocks and the last 2 discriminator blocks are trained based on the second sample data sets with a resolution of 8×8, completing the training; wherein the feature vector output by the second generative block is used as the feature vector output by the previous discriminator block received by the penultimate discriminator block, and the parameters of the first generative block and the last discriminator block use the parameters of the first generative block and the last discriminator block after the training is completed.

The conditional generative adversarial networks execute the following steps during the 3rd training:
assuming that generative blocks in the conditional generator network comprise the first 3 generative blocks and discriminator blocks in the discriminator network comprise the last 3 discriminator blocks, the first 3 generative blocks and the last 3 discriminator blocks are trained based on the second sample data set with a resolution of 16×16, completing the training; wherein the feature vector output by the 3rd generative block is used as the feature vector output by the previous discriminator block received by the penultimate 3rd discriminator block, and the parameters of the first 3 generative blocks and the last 3 discriminator blocks use the parameters of the first 3 generative blocks and the last 3 discriminator blocks after the 2nd training is completed;
and so on, the conditional generative adversarial network executes the following steps during the N_{g} th training:
all the generative blocks and the discriminator blocks are trained based on the second sample data set with the highest resolution, the trained conditional generative adversarial network is obtained after the training is completed; wherein during the last training, the first discriminator block does not need to receive the feature vector output by the previous discriminator block, and the parameters of the first N_{g}−1 generative blocks and the last N_{g}−1 discriminator blocks use the parameters of the first N_{g}−1 generative blocks and the last N_{g}−1 discriminator blocks after the N_{g}−1th training is completed.

It should be noted that, the layout samples can be combined within the network through downsampling during the actual training, if a photo is inputted, the second layout sample of the photo with the required resolution will be actively generated; that is, a layout sample is inputted into the network, then the second layout sample will be generated, to avoid the problem of errors in different images with different resolutions.

When implemented, the first k generative blocks and the last k discriminator blocks are trained based on the second sample data sets with a resolution of 2^{k+1}×2^{k+1}:
setting the optimizer, learning rate, training parameters, the third loss function and the fourth loss functions during training;
the second layout samples from the second sample data sets with a resolution of 2^{k+1}×2^{k+1} are taken sequentially for training:
fixing the parameters in the discriminator network, inputting the current second layout samples and the corresponding attribute labels into the conditional generative adversarial network for training, adjusting the parameters of the generator network in the conditional generator network through back propagation and SGD, so that the third loss function is minimized, and then obtain the generator network in the current trained conditional generator network;
fixing the parameters in the generator network, inputting the current second layout samples and the corresponding attribute labels into the conditional generative adversarial network for training, adjust the parameters of the discriminator network through back propagation and SGD, so that the fourth loss function is maximized, and then obtain the current trained discriminator network;
when the discriminator expectation of the discriminator network is a preset threshold or each second layout sample in the second sample data sets is trained, the training of the first k generative blocks and the last k discriminator blocks is completed.

Specifically, the threshold of the discriminator expectation is set to 0.5, i.e., the discriminator network is unable to distinguish between the layout generated sample and the second layout sample. It should be noted that the discriminator expectation can be calculated according to existing calculation methods and is not repeated here.

Specifically, in this embodiment, the optimizer adopts an Adam optimizer, the learning rate is 1e-6, and the training parameters are the specific data of the convolutional layers in each network, i.e., the training parameters are the specific values in the matrix.

Specifically, said third loss function is denoted as:

$${L}_{3} = - \frac{1}{{N}^{g}} {\sum }_{{i}^{′′′} = 1}^{{N}^{g}} {E}_{{ε}^{g} ∼ N ( 0 , {σ}^{2} )} log ( D ( G ( {z}_{{i}^{″}} , {y}_{{i}^{′′′}}^{g} + {ε}^{g} ) , {y}_{{i}^{′′′}}^{g} + {ε}^{g} ) ) ;$$

where N^{g} denotes the number of layout generative images, E_{ε}_{^{g}}_{˜N(0,σ}_{²}₎( ) denotes the expected value when random noise ε^{g} is added, wherein the random noise ε^{g} satisfies the distribution N(0, σ²);

$${y}_{{i}^{′′′}}^{g}$$

denotes the attribute labels of the i′″th second layout sample inputted;

$$G ( {z}_{i} , {y}_{i}^{g} + {ε}^{g} )$$

denotes the output result when the label

$${y}_{{i}^{′′′}}^{g}$$

of the conditional generator network is introduced, the random noise ε^{g} is applied, and its input is the random latent vector zᵢ,

$$D ( G ( {z}_{i} , {y}_{i}^{g} + {ε}^{g} ) , {y}_{i}^{g} + {ε}^{g} )$$

denotes the outputted discriminator probability of the discriminator network when the label

$${y}_{{i}^{′′′}}^{g}$$

is introduced, the random noise ε^{g} is applied, and its input is

$$G ( {z}_{i} , {y}_{i}^{g} + {ε}^{g} ) ;$$

N(0, σ²) denotes a normal distribution with a mean of 0 and a variance of σ².

Specifically, said fourth loss function is denoted as:

$${L}_{4} = - \frac{{C}_{3}}{{N}^{r}} {\sum }_{{j}_{1} - 1}^{{N}^{r}} {\sum }_{{i}_{1} = 1}^{{N}^{r}} {E}_{{ε}^{r} ∼ N ( 0 , {σ}^{2} )} [ {W}_{1} log ( D ( {x}_{{i}_{1}}^{r} , {y}_{{j}_{1}}^{r} + {ε}^{r} ) ) ] - \frac{{C}_{4}}{{N}^{g}} {\sum }_{{j}_{2} = 1}^{{N}^{g}} {\sum }_{{i}_{2} = 1}^{{N}^{g}} {E}_{{ε}^{g} ∼ N ( 0 , {σ}^{2} )} [ {W}_{2} log ( 1 - D ( {x}_{{i}_{2}}^{g} , {y}_{{j}_{2}}^{g} + {ε}^{g} ) ) ] ;$$

$$wherein ,$$

$${W}_{1} = \frac{{ω}^{r} ( {y}_{{i}_{1}}^{r} , {y}_{{j}_{1}}^{r} + {ε}^{r} )}{{\sum }_{{i}_{1} = 1}^{{N}^{r}} {ω}^{r} ( {y}_{{i}_{1}}^{r} , {y}_{{j}_{1}}^{r} + {ε}^{r} )} ,$$

$${W}_{2} = \frac{{ω}^{g} ( {y}_{{i}_{2}}^{g} , {y}_{{j}_{2}}^{g} + {ε}^{g} )}{{\sum }_{{i}_{2} = 1}^{{N}^{g}} {ω}^{g} ( {y}_{{i}_{2}}^{g} , {y}_{{j}_{2}}^{g} + {ε}^{g} )} ;$$

$${ω}^{r} ( {y}_{{i}_{1}}^{r} , {y}_{{j}_{1}}^{r} + {ε}^{r} ) = {e}^{- v ( {y}_{{i}_{1}}^{r} - ( {y}_{{j}_{1}}^{r} + {ε}^{r} ) )} ,$$

$${ω}^{g} ( {y}_{{i}_{2}}^{g} , {y}_{{j}_{2}}^{g} + {ε}^{g} ) = {e}^{- v ( {y}_{{i}_{s}}^{g} - ( {y}_{{j}_{2}}^{g} + {ε}^{g} ) )} ;$$

where E_{ε}_{^{g}}_{˜N(0,σ}_{²}₎ ( ) denotes the expected value when random noise ε^{r} is added, wherein the random noise ε^{r} satisfies the distribution N(0, σ²); N^{r} denotes the number of the second layout samples of the corresponding resolution;

$${x}_{{i}_{1}}^{r}$$

denotes the i₁ th second layout sample,

$${y}_{{j}_{1}}^{r}$$

denotes the attribute label feature vector of the j₁ th second layout sample inputted;

$${x}_{{i}_{2}}^{g}$$

denotes the i₂ th second layout generative image,

$${y}_{{j}_{2}}^{g}$$

denotes the attribute label feature vector of the j₂ th second layout sample inputted;

$$D ( {x}_{{i}_{1}}^{r} , {y}_{{j}_{1}}^{r} + {ε}^{r} )$$

denotes the outputted discriminator probability of the discriminator network when the label

$${x}_{{i}_{1}}^{r} ; D ( {x}_{{i}_{2}}^{g} , {y}_{{j}_{2}}^{g} + {ε}^{g} )$$

is introduced, the random noise ε^{r} is applied, and its input is

$${y}_{{j}_{1}}^{r}$$

denotes the outputted discriminator probability of the discriminator network when the label yⱼ_{₂}^{g} is introduced, the random noise ε^{g} is applied, and its input is

$${x}_{{i}_{2}}^{g} ;$$

C₃, C₄ denotes the first fixed parameter and the second fixed parameter respectively, v denotes non-negative parameter.

For example, in this embodiment, C₃=C₄=1.

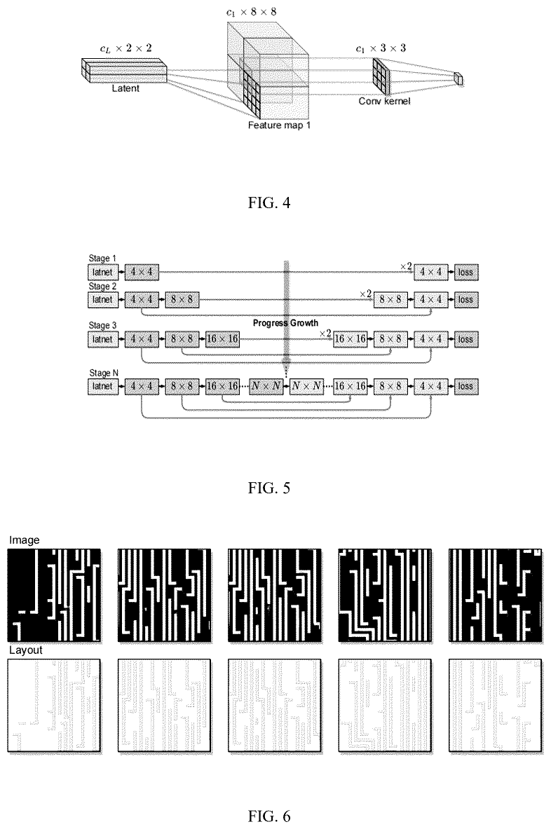

Understandably, the training method in this embodiment starts with image scale of low resolution and gradually increases the resolution by adding blocks to the network, as shown in FIG. 5. The training starts with image resolution of 4×4 at the smallest scale, there is only one block in both the generator network and the discriminator network respectively. As training progresses, the generative blocks and the discriminator blocks are added to the generator network and the discriminator network respectively, so that the number of network layers is gradually deepened, thus increasing the maximum resolution of the generated image. The overall network at N×N resolution is realized finally. This incremental training allows the network to learn the large-scale structure firstly, then gradually shift its attention to more localized detail scales as the blocks are inserted, on the other hand, the network operates at lower scales during the early iterations, so it can reduce the training time, and it can avoid a large number of corrections of the large-scale generative blocks in the generator network during the initial stage of the network training, which saves a lot of computational resources. In addition, all the generative blocks and the discriminator blocks are composed of convolutional layers, which are essentially matrices of defined size, while the nature of training is to constantly adjust the specific values of these matrices.

It should be noted that in the conditional generative adversarial network, when given a regression constraint label, its implicit embedding vector can be obtained by the trained label embedding network and the embedding vector is inserted into the network as a condition. For the generator network, Conditional Batch Normalization is used to insert the conditional embedding vector in each generative block. There is a potential problem when using normal batch normalization in the conditional generative adversarial network, there are sample feature images corresponding to various constraint conditions in one batch, it does not make sense to put them together for normalization. Because features with different conditions should correspond to different means and variances, the normalization, deflation and bias should also be performed differently for them. The conditional batch normalization in this embodiment takes the sample conditions as inputs, and determines the normalization operation parameters for each sample together with the features, for the discriminator network, the conditional embedding vectors are introduced into the reasoning of the discriminator through label projection, which makes it more accurate and reasonable in this embodiment.

It should be noted that in this embodiment the conditional generative adversarial network which the label embedding network added is obtained by the following derivation:
in some special application scenarios, not only diversified test graphics are required, but also certain global attributes of the test graphics are required, adding the label embedding network in this embodiment can generate test layouts that satisfy user's specific conditions.

Adopting a loss function based on Vicinal Risk Minimization (VRM) can effectively solve the dilemma faced by traditional generative adversarial networks in continuously constrained tasks. Vicinal Risk Minimization assumes that a sample shares the same label with other samples in the vicinity of its distribution. Under the guidance of vicinal risk minimization, when estimating the regression conditional distribution p(x|y) (x is a generated sample, y is a regression label), it can be assumed that the change in p(x|y) due to small perturbations of y is negligible. This assumption is consistent with the actual situation in the layout generative task. For example, the distribution of features in a layout slice with a local density of 0.26 should be close to the distribution of a layout slice with a density of 0.25.

Therefore, replacing the objective function based on empirical risk minimization with the objective function based on vicinaling risk minimization can adapt to the regression labels corresponding to the samples. The discriminator loss L(D) and the generative loss L(G) of the original loss (Vanilla GAN Loss) function in the conditional generative adversarial network are respectively:

$$L ( D ) = - {E}_{y ∼ {p}_{r} ( y )} [ \text{} {E}_{x ∼ {p}_{r} ( x \vert y )} [ \text{} log ( D ( x , y ) ) ] ] - \text{} {E}_{y ∼ {p}_{s} ( y )} [ \text{} {E}_{x ∼ {p}_{g} ( x \vert y )} [ \text{} log ( 1 - D ( G ( x , y ) ) ) ] ] = \text{} - \int log ( D ( x , y ) ) {p}_{r} ( x , y ) dxdy - \int log ( 1 - D ( x , y ) ) {p}_{g} ( x , y ) dxdy ;$$

$$L ( G ) = - {E}_{y ∼ {p}_{r ( y )}} [ \text{} {E}_{z ∼ q ( z )} [ \text{} log ( D ( G ( z , y ) , y ) ) ] ] = \text{} - \int log ( D ( G ( x , y ) , y ) ) q ( z ) {p}_{g} ( y ) dzdy ;$$

where E_{y˜p}_{ᵣ}_{(y)}( ) denotes the expected value when adding the regression label y, wherein the regression label y satisfies the distribution pᵣ(y); E_{y˜p}_{_{g}}_{(y)} ( ) denotes the expected value when adding the regression label y, wherein the regression label y satisfies the distribution p_{g}(y); E_{x˜p}_{ᵣ}_{(x|y)}( ) denotes the expected value when adding the generated sample x, wherein the real sample (that is, authentic sample) x satisfies the distribution pᵣ(x|y); E_{x˜p}_{_{g}}_{(x|y)}( ) denotes the expected value when adding the generated sample x, wherein the generated sample x satisfies the distribution p_{g}(x|y); E_{z˜q(z)} denotes the expected value when inputting the noise z, wherein the noise z satisfies the distribution q(z); D(x, y) denotes the output value when the input of the discriminator network is x and the label is y; D(G(x, y)) denotes the output value when the input of the discriminator network is G(x, y); pᵣ(x, y) and p_{g}(x, y) denote the true and the generated joint probability distribution of x and y respectively; pᵣ(x|y) denotes the conditional probability distribution of the real sample x under the condition of satisfying the label y; p_{g}(x|y) denotes the conditional probability distribution of the generated sample x under the condition of satisfying the label y; G(x, y) denotes the output value when the input of the generator network is x and the label is y; D(G(z, y), y) denotes the output value when the input of the discriminator network is G(x, y) and the label is y;
wherein pᵣ(y) and p_{g}(y) are the Marginal Distribution of the true and the generated labels respectively, pᵣ(x|y) and p_{g}(x|y) are the true and the generated Joint Distribution of the sample x and the label y respectively; q(z) is the input noise obtained by random sampling from the latent space.

Since the distributions in the above equations are unknown, they need to be estimated according to vicinal risk minimization (VRM), the estimation of pᵣ(x|y) and p_{g}(x|y) are defined as:

$${p}_{r}^{VRM} ( x , y ) = {C}_{1} ⌈ \frac{1}{{N}^{r}} {\sum }_{j = 1}^{{N}^{′}} exp ( - \frac{{( y - {y}_{j}^{r} )}^{2}}{2 {σ}^{2}} ) ⌉ \cdot [ \frac{{\sum }_{i = 1}^{{N}^{′}} {ω}^{r} ( {y}_{i}^{r} , y ) δ ( x - {x}_{i}^{r} )}{{\sum }_{i = 1}^{{N}^{′}} {ω}^{r} ( {y}_{i}^{r} , y )} ] ;$$

$${p}_{9}^{VRM} ( x , y ) = {C}_{2} ⌈ \frac{1}{{N}^{g}} {\sum }_{j = 1}^{{N}^{g}} exp ( - \frac{{( y - {y}_{j}^{g} )}^{2}}{2 {σ}^{2}} ) ⌉ \cdot [ \frac{{\sum }_{i = 1}^{{N}^{g}} {ω}^{g} ( {y}_{i}^{g} , y ) δ ( x - {x}_{i}^{g} )}{{\sum }_{i = 1}^{{N}^{g}} {ω}^{g} ( {y}_{i}^{g} , y )} ] ;$$

wherein

$${x}_{i}^{r} and {x}_{i}^{g}$$

represent the ith real sample and the ith generated sample respectively,

$${y}_{j}^{r} and {y}_{j}^{g}$$

are the respective labels respectively, N^{r} and N^{g} are the number of real samples and the number of generated samples respectively, σ is a non-negative hyperparameter, C₁ and C₂ are constants of the probability density function that makes the two estimation valid. δ is the Dirac function, a part of the first square bracket implies that Kernel Density Estimates (KDEs) are used to estimate the marginal label distributions pᵣ(y) and p_{g}(y). The design in the second square bracket is based on the assumption mentioned above, the changes in pᵣ(x|y) and p_{g}(x|y) due to small perturbations of y is negligible. If this assumption holds, samples whose labels are within a certain range in the vicinity of y can be used to estimate pᵣ(x|y) and p_{g}(x|y), and the corresponding weights

$${ω}^{r} ( {y}_{j}^{r} , y ) and {ω}^{g} ( {y}_{j}^{g} , y )$$

can be assigned according to the distance from the sample labels to y.

$${ω}^{r} ( {y}_{i}^{r} , y ) = {e}^{- {v ( {y}_{i}^{r} - y )}^{2}} , {ω}^{g} ( {y}_{i}^{g} , y ) = {e}^{- {v ( {y}_{i}^{g} - y )}^{2}} ;$$

wherein v is a non-negative parameter, combining the above formulas, the vicinal loss function for the discriminator and the generator can be obtained as follows respectively:

$${L}^{VRM} ( D ) = - \frac{{C}_{3}}{{N}^{r}} {\sum }_{{j}_{1} = 1}^{{N}^{′}} {\sum }_{{j}_{1} = 1}^{{N}^{′}} {E}_{{ε}^{r} \sim N ( 0 , {σ}^{2} )} [ {W}_{1} log ( D ( {x}_{{i}_{1}}^{r} , {y}_{{i}_{1}}^{r} + {ε}^{r} ) ) ] - \frac{{C}_{4}}{{N}^{g}} {\sum }_{{j}_{2} = 1}^{{N}^{g}} {\sum }_{{j}_{2} = 1}^{{N}^{g}} {E}_{{ε}^{g} \sim N ( 0 , {σ}^{2} )} [ {W}_{2} log ( 1 - D ( {x}_{{i}_{2}}^{g} , {y}_{{i}_{2}}^{g} + {ε}^{g} ) ) ] ;$$

$${L}^{VRM} ( G ) = - \frac{1}{{N}^{g}} {\sum }_{{i}^{″} = 1}^{{N}^{g}} {E}_{{ε}^{g} \sim N ( 0 , {σ}^{2} )} log ( D ( G ( {𝓏}_{{i}^{″}} , {y}_{{i}^{″}}^{g} + {ε}^{g} ) , {y}_{{i}^{″}}^{g} + {ε}^{g} ) ) ;$$

$$wherein , {ε}^{r} = y - {y}_{j}^{r} , {ε}^{g} = y - {y}_{j}^{g} , {W}_{1} = \frac{{ω}^{r} ( {y}_{i}^{r} , {y}_{j}^{r} + {ε}^{r} )}{{\sum }_{i = 1}^{{N}^{r}} {ω}^{g} ( {y}_{i}^{r} , {y}_{j}^{r} + {ε}^{r} )} ,$$

$${W}_{2} = \frac{{ω}^{g} ( {y}_{i}^{g} , {y}_{j}^{g} + {ε}^{g} )}{{\sum }_{i = 1}^{{N}^{g}} {ω}^{g} ( {y}_{i}^{g} , {y}_{j}^{g} + {ε}^{g} )} ; {C}_{3} = {C}_{4}$$

is a specific parameter which can be ignored when minimizing the loss function. During training, when given a label y as a training condition, the discriminator network can be trained using the samples whose labels are in the vicinity of y, rather than just using the samples with label y. This makes it possible to estimate pᵣ(x|y) reasonably even there are not enough corresponding samples.

Since the loss function applicable to the regression label conditional constraints does not depend on any particular network structure, the introduction of the conditional constraints is added to the generative adversarial network in this embodiment to obtain the conditional generative adversarial network in this embodiment.

S4, the conditional generator network in the trained conditional generative adversarial network is used as a conditional test layout generator.

Understandably, the test layout dimension to be generated and the attribute labels are inputted into the trained conditional generator network to obtain the test layouts.

Compared to the prior art, the present embodiment provides a method for constructing conditional test layout generator, by obtaining a preset number of original layouts and adding attribute label to each original layout to obtain first sample data sets, and processing each first sample data set to obtain a second sample data set of each resolution, and then constructing a label embedding network, and training said label embedding network based on a feature extraction network, a feature regression network and said first sample data sets to obtain a trained label embedding network, followed by constructing a conditional generative adversarial network which is composed of a conditional generator network and a discriminator network, the conditional generator network comprises a trained label embedding network and a generator network, finally training the conditional generative adversarial network based on the size of the test layouts to be generated, the preset number of channels and the second sample data set of each resolution, the trained conditional generator network is used as a conditional test layout generator, the generator thus constructed is capable of generating test layouts with specific layout attributes, which improves the utilization rate of computational resources, meets the diversified requirements of layout testing nowadays, and is capable of generating high-quality large-size continuous layouts with guaranteed diversity of generated layouts.

An embodiment of the present application provides a method for calibrating lithography model, comprising:
generating test layouts with specific layout attributes by a conditional test layout generator, wherein constructing the conditional test layout generator comprises the following steps: obtaining a preset number of original layouts, adding attribute label to each original layout to obtain first sample data sets; at the same time, processing each first sample data set to obtain a second sample data set of each resolution; wherein each attribute label is a specific value of a preset layout attribute; constructing a label embedding network, training the label embedding network based on a feature extraction network, a feature regression network and the first sample data sets to obtain a trained label embedding network; constructing a conditional generative adversarial network, wherein the conditional generative adversarial network comprises a conditional generator network and a discriminator network, the conditional generator network comprises the trained label embedding network and a generator network; training the conditional generative adversarial network based on the size of the test layouts to be generated, a preset number of channels, and the second sample data set of each resolution to obtain a trained conditional generative adversarial network; using the conditional generator network in the trained conditional generative adversarial network as a conditional test layout generator;
inputting the test layouts with the specific layout attributes into a lithography model to calibrate lithography model.

In addition, an embodiment of the present application provides a method for improving Source Mask Optimization (SMO) comprising: generating test layouts with specific layout attributes by a conditional test layout generator; using the test layouts with specific layout attributes to optimize SMO simulation.

In addition, an embodiment of the present application provides a method for generating training data of hotspot detection, wherein test layouts with specific layout attributes generated is used as training data of hotspot detection.

An embodiment of the present application provides a non-transitory machine-readable storage medium comprising instructions that when executed cause a processor of a computing device to:
obtaining a preset number of original layouts, adding attribute label to each original layout to obtain first sample data sets; at the same time, processing each first sample data set to obtain a second sample data set of each resolution; wherein each attribute label is a specific value of a preset layout attribute;
constructing a label embedding network, training the label embedding network based on a feature extraction network, a feature regression network and the first sample data sets to obtain a trained label embedding network;
constructing a conditional generative adversarial network, wherein the conditional generative adversarial network comprises a conditional generator network and a discriminator network, the conditional generator network comprises the trained label embedding network and a generator network; training the conditional generative adversarial network based on the size of the test layouts to be generated, a preset number of channels, and the second sample data set of each resolution to obtain a trained conditional generative adversarial network;
using the conditional generator network in the trained conditional generative adversarial network as a conditional test layout generator.

GPU can be used for training the test pattern generator, for example the processor of a computing device may be a GPU.

Test patterns with specific attributes generated by the conditional test pattern generator can be applied to the following hardware:
1. Lithography System: the conditional test pattern generator can automatically generate a large number of test layout patterns with specific attributes, these test patterns can be used as inputs of lithography simulation model, for performing exposure simulation, development simulation, etc. to obtain simulation data. Then the simulation data can be used to adjust the parameters of the lithography machine (such as, focal length, dose, mask optimization), which in turn improve the lithography yield and optimize the process window.
2. Test wafers and measurement device from semiconductor manufacture (Foundry): the conditional test pattern generator may provide test structures of ‘Customized, High-Diversity, and Highly Realistic Simulation’ for the test wafers and the measurement equipment, for example, creating test patterns with variable critical dimensions (CDs), pitches, and fill structures, etc., then performing exposure of the test patterns. The exposure test patterns can be used to measure actual wafer data for testing CD uniformity and OPC corrections, and thus improve accuracy of measurement device.

In addition, an embodiment of the present application provides a lithography system for adjusting parameters of a lithography machine, comprising:
a computing device comprises a non-volatile machine-readable storage medium and a Graphics Processing Unit (GPU), wherein the non-volatile machine-readable storage medium comprising instructions that when executed cause the GPU to generate test layout patterns with specific layout attributes by the conditional test pattern generator according to above embodiment; and the test layout patterns are configured to perform exposure simulation and development simulation to obtain simulation data;
lithography machine comprises light source, reticle (mask) stage, projection optics system, etc., wherein a focal length of the projection optics system and exposure dose are adjusted and the mask is optimized according to the simulation data, to improve wafer pattern generated by lithography process. The light source and the projection optics system are used to expose a wafer to transfer the pattern of mask on reticle (mask) stage to the surface of wafer.

In order to verify the effectiveness and correctness of the generative method in this embodiment, based on the ICCAD 2012 data set, collecting raw data from which for the generator training. The purpose of the conditional test layout generator is to make up for the lack of real designs at the early stage of technology node development, therefore, instead of using all the samples, 500 layout slices randomly sampling from the data set are used as the training set in this embodiment. The original data layout corresponds to a minimum key size of 45 nm in the design rule constraints (DRC), setting the sub-block size of a given grid to 5 nm during the layout pixelization of the training set, which provides sufficient resolution to characterize the various detailed structures in the layout, such as the relative positions between lines and ends as well as the step structures on the lines. After the incremental growth style training of the conditional generative adversarial network, a modified generator network is obtained as the layout image generator. In the actual generative process, a latent vector with dimension 1×128×1×1 is inputted into the generator, the output layout graphic is post-processed to obtain the final generated layout. Some generative results are shown in FIG. 6. Wherein the latent vector comprises batch_size (the number of data (samples) passed to the program for training at a single time), channels (the number of channels), height (image height) and width (image width), the size of the test layout can be controlled by modifying the height (image height) and width (image width) in practical applications.

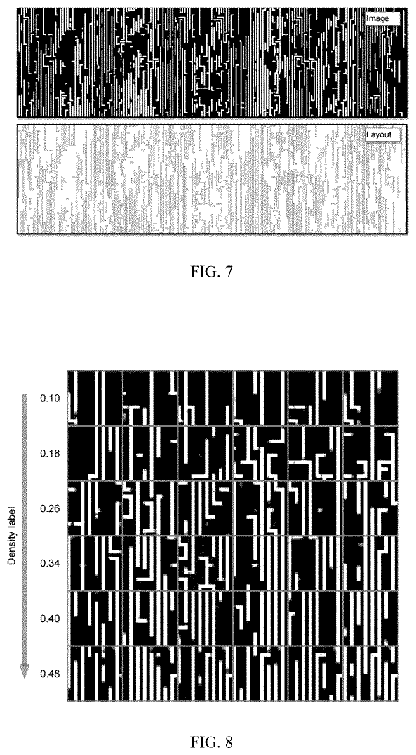

It can be seen from the example results that the layout images output from the generator are already very regular and have a high degree of similarity to the design features of the original layouts. In order to generate a large-size continuous layout, the dimension of the latent tensor is extended, by inputting a random tensor of 1×128×10×10 to the (Muti-Scale Gradient Generative Adversarial Net) MSG-GAN, the size of the output layout image will also be 10 times the size of the previous layout slices, the output image is shown in FIG. 7. The test layout generated by the present application is large in size and continuous everywhere without stiff splicing structure, and the layouts after post-processing almost all meet the requirements of the design rule constraints (DRC) too.

And the continuous conditional generative adversarial network can generate the layout images with the corresponding attributes according to the inputted continuous label conditions, the example results are shown in FIG. 8. In this embodiment, 6 progressively increasing local density labels are given sequentially, from 0.10 to 0.48. Each time, 6 identical latent vectors are used for the generation, which correspond to the 6 layout images of each row in the figure. It can be seen from the results that as the given regression condition value increases, the local density of the generated layout image also increases progressively, at the same time, the generated samples corresponding to each condition also have sufficient diversity, and there is no problem of mode crash.

A person skilled in the art can understand that all or part of the process of implementing the methods of the above embodiments may be implemented by related hardware according to an instruction from a computer program, and the program may be stored in a computer-readable storage medium, wherein the computer-readable storage medium is a magnetic disc, an optical disc, a read-only memory, a random access memory and so on.

The above are merely preferable particular embodiments of the present application, and the protection scope of the present application is not limited thereto. All of the variations or substitutions that a person skilled in the art can easily envisage within the technical scope disclosed by the present application should fall within the protection scope of the present application.

1. A method for constructing conditional test layout generator, comprising the following steps:
obtaining a preset number of original layouts, adding attribute label to each original layout to obtain first sample data sets; at the same time, processing each first sample data set to obtain a second sample data set of each resolution; wherein each attribute label is a specific value of a preset layout attribute;
constructing a label embedding network, training the label embedding network based on a feature extraction network, a feature regression network and the first sample data sets to obtain a trained label embedding network;
constructing a conditional generative adversarial network, wherein the conditional generative adversarial network comprises a conditional generator network and a discriminator network, the conditional generator network comprises the trained label embedding network and a generator network; training the conditional generative adversarial network based on the size of the test layouts to be generated, a preset number of channels, and the second sample data set of each resolution to obtain a trained conditional generative adversarial network;
using the conditional generator network in the trained conditional generative adversarial network as a conditional test layout generator.

2. The method for constructing conditional test layout generator according to claim 1, wherein said layout attributes comprise layout density, layout complexity, E2L or L2L; wherein E2L denotes an end-to-line spacing and L2L denotes a line-to-line spacing.

3. The method for constructing conditional test layout generator according to claim 1, wherein said feature extraction network is used to extract the features of inputted first layout samples to obtain feature vectors;
said feature regression network is used to map the received feature vectors to attribute labels;
said label embedding network is used to map the attribute labels back to the corresponding feature vectors.

4. The method for constructing conditional test layout generator according to claim 3, wherein said label embedding network is trained by the following way:
after sequentially connecting said feature extraction network and said feature regression network, performing training based on the first sample data sets and a preset first loss function to obtain a trained feature regression network;
after connecting the input terminal of said label embedding network to the output terminal of the trained feature regression network, and connecting the output terminal of said label embedding network to the input terminal of the trained feature regression network, performing training based on each attribute label in said first sample data sets and a preset second loss function to obtain the trained label embedding network.

5. The method for constructing conditional test layout generator according to claim 4, wherein the feature regression network is trained based on the first sample data sets and the preset first loss function by the following way:
setting the optimizer, learning rate, training parameters, and first loss function which are used for the training process;
inputting each first layout sample in the first sample data sets into the feature extraction network, and adjusting the parameters of the feature regression network by back propagation and SGD, so that the first loss function is minimized, and then the trained feature regression network is obtained.

6. The method for constructing conditional test layout generator according to claim 5, wherein the label embedding network is trained based on each attribute label in said first sample data sets and the preset second loss function by the following way:
setting the optimizer, learning rate, training parameters, and second loss function which are used for the training process;
inputting each attribute label in the first sample data sets into the label embedding network, and adjusting the parameters of the label embedding network by SGD method, so that the second loss function is minimized, and then the trained label embedding network is obtained; wherein the parameters in the trained feature regression network remain unchanged.

7. The method for constructing conditional test layout generator according to claim 3, wherein said feature extraction network comprises M extraction units connected in sequence, wherein the 1st to the M−1th extraction units all comprise two third convolutional layers and one pooling layer which are connected in sequence, and the Mth extraction unit comprises two third convolutional layers and one fourth convolutional layer which are connected in sequence; wherein the number of the extraction units is obtained according to the highest resolution of the test layouts to be generated;
said feature regression network comprises two first convolutional layers connected in sequence;
said label embedding network comprises two first convolutional layers connected in sequence.

8. The method for constructing conditional test layout generator according to claim 4, wherein said first loss function L₁ is denoted as:
$${L}_{1} = \frac{1}{n} {\sum }_{i = 1}^{n} [ {( {T}_{h 2 y} ( {T}_{x 2 h} ( {x}_{i} ) ) - {y}_{i} )}^{2} ] ;$$
where n denotes the number of the first layout samples in the first sample data sets, xᵢ denotes the ith first layout sample, yᵢ denotes the attribute label corresponding to xᵢ, Tₓ₂ₕ(xᵢ) denotes the output result when the input of the feature extraction network is xᵢ; T_{h2y}(Tₓ₂ₕ(xᵢ)) denotes the output result when the input of the feature regression network is Tₓ₂ₕ(xᵢ).

9. The method for constructing conditional test layout generator according to claim 8, wherein said second loss function L₂ is:
$${L}_{2} = \frac{1}{m} {\sum }_{{i}^{′} = 1}^{m} {E}_{γ \sim N ( 0 , {σ}_{γ}^{2} )} [ {( {T}_{h 2 γ} ( {T}_{γ 2 h} ( {y}_{{i}^{′}}^{u} + γ ) ) - ( {y}_{{i}^{′}}^{u} + γ ) )}^{2} ] ;$$
where m denotes the number of attribute label types;
$${y}_{{i}^{′}}^{u}$$
denotes the attribute labels of the i′ type;
$${E}_{γ \sim N ( 0 , {σ}_{γ}^{2} )}$$
( ) denotes the expected value when random noise γ is added, wherein the noise γ satisfies the distribution
$$N ( 0 , {σ}_{γ}^{2} ) ; {T}_{y 2 h} ( {y}_{{i}^{′}}^{u} + γ )$$
denotes the output result when random noise γ is applied to input
$${y}_{{i}^{′}}^{u}$$
of the label embedding network;
$${T}_{h 2 y} ( {T}_{y 2 h} ( {y}_{{i}^{′}}^{u} + γ ) )$$
denotes the output result when input of the feature regression network is
$${T}_{y 2 h} ( {y}_{{i}^{′}}^{u} + γ ) ; N ( 0 , {σ}_{γ}^{2} )$$
denotes a normal distribution with a mean of 0 and a variance of
$${σ}_{γ}^{2} .$$

10. The method for constructing conditional test layout generator according to claim 1, wherein said processing each first sample data set to obtain a second sample data set of each resolution comprises:
downsampling operation with different resolutions is performed on each first layout sample in each first sample data set respectively to obtain each second layout sample with resolution of 4×4, 8×8, 16×16, . . . , N/2×N/2, and then each first layout sample is used as each second layout sample with resolution of N×N, the second layout samples with the same resolution constitute the second sample data sets at different resolutions; wherein N×N is the highest resolution required for the test layouts to be generated.

11. A method for calibrating lithography model, comprising:
generating test layouts with specific layout attributes by a conditional test layout generator, wherein constructing the conditional test layout generator comprises the following steps:
obtaining a preset number of original layouts, adding attribute label to each original layout to obtain first sample data sets; at the same time, processing each first sample data set to obtain a second sample data set of each resolution; wherein each attribute label is a specific value of a preset layout attribute;
constructing a label embedding network, training the label embedding network based on a feature extraction network, a feature regression network and the first sample data sets to obtain a trained label embedding network;
constructing a conditional generative adversarial network, wherein the conditional generative adversarial network comprises a conditional generator network and a discriminator network, the conditional generator network comprises the trained label embedding network and a generator network; training the conditional generative adversarial network based on the size of the test layouts to be generated, a preset number of channels, and the second sample data set of each resolution to obtain a trained conditional generative adversarial network;
using the conditional generator network in the trained conditional generative adversarial network as a conditional test layout generator;
inputting the test layouts with the specific layout attributes into a lithography model to calibrate lithography model.

12. A lithography system for adjusting parameters of a lithography machine, comprising:
a computing device comprises a non-volatile machine-readable storage medium and a Graphics Processing Unit (GPU), wherein the non-volatile machine-readable storage medium comprising instructions that when executed cause the GPU to generate test layout patterns with specific layout attributes by the conditional test pattern generator according to claim 1; and the test layout patterns are configured to perform exposure simulation and development simulation to obtain simulation data;
lithography machine comprises reticle (mask) stage, projection optics system, wherein a focal length of the projection optics system and exposure dose are adjusted and a mask on the reticle (mask) stage is optimized according to the simulation data, to improve wafer pattern generated by lithography process.
